(19) United States
(12) Patent Application Publication
(10) Pub. No.: US 2025/0313363 A1
(43) Pub. Date: Oct. 9, 2025

(54) BUCKLE WITH TENSION INDICATOR

(71) Applicant: Band-It-IDEX, Inc., Denver, CO (US)

(72) Inventors: Stephen C. Galante, Denver, CO (US); Ryan M. Stoltz, Commerce City, CO (US)

(21) Appl. No.: 19/241,039

(22) Filed: Jun. 17, 2025

Related U.S. Application Data
(63) Continuation-in-part of application No. 18/542,244, filed on Dec. 15, 2023, now Pat. No. 12,338,847.
(60) Provisional application No. 63/433,287, filed on Dec. 16, 2022.

(51) Int. Cl. B65B 13/22; B65B 13/34; F16B 2/08

(52) U.S. Cl. CPC B65B 13/22; B65B 13/34; F16B 2/08; F16B 2200/95

(57) ABSTRACT

A buckle and a band for installation onto a workpiece are provided. The buckle includes a tension indicator for indicating when a desired tension on the band has been reached during installation. The tension indicator may be a collapsible wing that moves from a first position to a second position to provide a visual indication of a tension applied to a band associated with the buckle.

### CROSS-REFERENCE TO RELATED APPLICATIONS

This U.S. Non-Provisional patent application is a continuation in part of U.S. application Ser. No. 18/542,244, filed on Dec. 15, 2023, which claims the benefit of priority from U.S. Provisional Patent Application Ser. No. 63/433,287, filed Dec. 16, 2022, the entire disclosure of which is hereby incorporated by reference.

### FIELD OF THE INVENTION

Embodiments of the present invention are related generally to installing bands with a buckle clamp assembly, and in particular to a buckle with a tension indicator to visually indicate when a desired tension on the band is reached.

### BACKGROUND

Users want to know that when they install band and buckle clamp assemblies, the bands have the correct amount of retained force and installations are consistent for each installer and from installer to installer. Some installation tools, for example, model UL 4000-D sold by BAND-IT-IDEX, Inc, Denver, Colorado, USA, are configured to monitor and set the tension applied to a band during installation. Such automated tools tend to be more expensive compared to manual tools and therefore much less likely to be used in situations where multiple installers each require their own tool. Because manual tensioning tools are generally robust and reliable, and were introduced much earlier in time compared to automated tensioning tools and are less expensive, manual tensioning tools vastly outnumber automated tensioning tools in use today for installing band clamps. Therefore, there is a need in the market to sidestep the prohibitive cost of automated tools and develop a clamping system and technique that repeatedly and reliably achieves a targeted retained force using a manual tool. The embodiments according to the present disclosure achieve this objective by incorporating a tension indictor into the design of the buckle not the tool.

Manual installation tools and procedures used with existing band and buckle clamps do not assess or indicate to the user the amount of applied force or the amount of retained force of a band achieved as a part of installation. Currently, the clamp design and manual installation procedure doesn't provide the installer or user confidence that the bands are installed correctly. Due to the nature of the tools and installation methods, an installer applies a force to the tool, which in turn applies a force to the band and buckle to achieve a targeted retained force (or clamp force). However, following installation, the retained or clamped force can vary significantly from installer to installer particularly for new or inexperienced installers. In many instances, there is no obvious visual indicator, such as a physical feature on the band or buckle, that definitively tells or indicates that the bands have been installed correctly. Additionally, current band and buckle designs used with manual tensioning tools require an installation procedure which introduces high variability from user to user and the possibility of an over or under tensioned clamp. Under tensioned clamps can move, vibrate, or provide insufficient retained force for an application, while over tensioned bands can cause bands or buckles to tear resulting in a failed product.

With reference to FIG. 1, a manual tensioning tool (model C00169) sold by BAND-IT-IDEX Corporation, Denver, Colorado, USA, is shown. A Band-It three-quarter inch Ear-Lokt buckle associated three-quarter inch band, each also made and sold by BAND-IT-IDEX Corporation, are also illustrated and engaged with the tool. An enlarged illustration of the buckle is shown in FIG. 3. As illustrated in FIG. 1, the band is ready for tensioning. The tool 10 includes a frame 12, a nose 20 attached to the frame, a band slot 22 located in the nose 20, a gripper 24, a clamp lever 26 and a rotary tension handle 28 interconnected to the gripper 24 by a threaded rod 30. After placing the band 32, buckle 34, and objects to be clamped in the proper position, in a first step the user or installer tensions the band by rotating the tension handle 28 to pull the gripper 24 away from the nose 20. In a second step, illustrated in FIGS. 2A and 2B, while the band is still secured in the tool 10, the tool is rotated away from the user or installer to roll the band and tool over the buckle while the user also unwinds the tension handle 28 to release some tension in the band. Excess band length 32 is then cut off by activating the cutting lever 36. If the buckle includes retaining tabs 38 or “ears”, the user then bends the two retaining tabs 38 over the free end of the band in order to secure further the band in place. If the band is under-tensioned by the installer in the first step, the targeted retained force is not met and the installation fails. As known to those of skill in the art, ff the installer over tensions the band in the first step and fails to release the over tension during the second step, when the tool is used to bend the band around the buckle, approximately two-hundred to three-hundred additional pounds of force will be applied to the band and the band will often yield and break and the installation fails. As a result, tension must be released from the band by the installer prior to or as part of the second step. When using a manual tool, the level of tension to apply in the first step and the amount of tension to release in connection with the second step is not displayed or otherwise quantified for the installer. The correct amount of tension to apply and the correct amount of tension to release is learned with experience and repetition and can vary among installers. Under tensioning is often a greater concern than over tensioning because in most situations when a band is over tensioned, the band will tear, crack or even break. When a band is under tensioned there typically is no visual indication to the installer or an inspector.

To address some of these problems, some current manual tensioning procedures rely on an installer to monitor the movement of stamped indicia on the band or installer drawn markings placed on the band. When the indicia or markings stop moving during tensioning, the band has reached the yield point and should not be tensioned any more. In reality, tensioning until the band no longer moves over tensions the band and also introduces subjectivity into the tensioning process undermining the objective of consistency and repeatability. To prevent adding more tension in the band or tearing the band in connection with step two, prior to cutting the excess band off and locking it in place, the installer unwinds the tensioning handle 28, typically by about a half turn, while rotating the tool and band over the buckle. If the unwinding step is done incorrectly, two results can occur. First, if not enough tension is eliminated, the band can tear on the teeth of the buckle and result in the installer redoing the entire procedure with a new band and buckle. Second, the tensioning mechanism can be unwound too far resulting in an insufficient or low retained force and causing the band to fail by not securing the desired component to the targeted structure, pole or object.

In summary, the existing design of band and buckle clamps used with a manual tensioning tool does not provide an indicator that proper tension has been achieved and requires an installation procedure which is inherently variable and subject to user error and incorrect installations. Accordingly, there is a need in the area of band clamping for an improved system, method and apparatus of manually tensioning a band relative to a buckle and circumscribed object that provides consistency and repeatability among all installers regardless of experience.

### SUMMARY

By adding a visual feature in the buckle that yields at a known tensile range and provides a predetermined orientation, the installer has a non-subjective indicator that indicates that the band and buckle are installed correctly with the targeted retained force to hold the desired component in place. Since there is an indication that proper tension has been achieved, the new designed buckle enables an installation procedure which does not require the user to release tension during roll over and thus greatly reduces installation variability while also increasing the band retained force. It also provides post-installation visual verification that a minimum targeted force was applied by the installer to the band and buckle.

For installation, one end of the band is bent back on itself to form a loop of band material. In one embodiment, the loop is wrapped around the leading end of the buckle while the opposite free end of the band is threaded through the buckle opening, around the object or objects being bound, and is fed back through the buckle opening once again. An automatic or manual hand tool engages and pulls the free end of the band through the buckle opening, adding a tensile force to the band. To resolve or at least reduce the subjectivity involved in correctly tensioning the band, in one embodiment according to the present disclosure, two strips or tabs of metal, referred to as wings, are formed integral with the buckle at the leading end of the buckle. The wings may be in the same plane as the buckle base or slightly above the same plane as the buckle base. The two wings could be asymmetric, each could have a different geometry, or each formed from a different material, etc. It will be appreciated that in other embodiments, the tabs or metal wings can be in a different plane as the buckle base. The wings extend outwardly from the buckle at an acute angle relative to the centerline of the buckle. In at least one embodiment, the tips of the wings extend outwardly beyond the lateral or side edges of the band.

In one embodiment, the wings are formed at the leading end of the buckle and one or more loops of band material wrap over the wings and through the buckle. The tips of the wings are visible to the installer with the band in place. During tensioning, the hand tool pulls the free end of the band causing the band to move through the buckle while the one or more loops of band material cause the buckle wings to move from a first position to a second position. The buckle wings bend under the resultant compressive force of the one or more loops of band material caused by the tensile force from the hand tool. Increasing the tension in the band reorients or repositions the wings to a predetermined second position and visually indicates the correct tension has been met.

In another embodiment according to the present disclosure, a single tab or wing is provided proximate the leading end of the buckle. The single tab or wing extends laterally outward from the body of the buckle in a first position at an acute angle relative to the centerline of the buckle. The tip or distal end of the tab or wing may extend past the lateral edge of a band held by the tensioning tool. Optionally, the buckle may also include a band guide extending from the body of the buckle proximate the leading end which functions to engage and align the opposite lateral or side edge of a band. The guide assists in properly orienting the band relative to the buckle. The guide may include a chamfered leading edge to assist in orienting the band into the guide.

In yet another embodiment according to aspects of the present disclosure, the one or more tension indicating tabs or wings may include one or more cut out portions, notches or surface configurations within the geometry of the tab and/or buckle that establish one or more locations where the tab or wing will bend or deform upon tensioning by the installation tool. The purpose of the particularized surface configuration is to create one or more locations where the wing or buckle will deform and thereby control the manner in which the wing bends or deforms. Such one or more surface configurations also assist in predetermining the location and position of the wing indicating that the targeted tension has been attained.

In other embodiments according to aspects of the present disclosure, the shape of the tab or wing may include enhancements or extensions that assist in identifying when a proper or intended tension is achieved. A shape or profile of a tab or wing may be such that one edge of a tab or wing is designed and configured to abut an edge of the body of the buckle and form a linear interface where the edges abut in a parallel orientation. In another embodiment, a leg or flange my extend from either the body of the buckle or the tab or wing such that upon deformation during tensioning, the leg or flange contacts the body of the buckle (if the leg is formed on the tab or wing) or contacts the tab or wing (if the leg is formed on the body of the buckle) to provide a visual indication to the installer that the band it properly tensioned. If the leg or flange is sufficiently robust, it may also prevent or reduce the likelihood of the operator over tensioning the band by resisting tensioning once contact is made between the leg or flange, on one side, and the buckle or tab/wing, on the other side.

Since the desired tensile force in the band can be predetermined by the material properties and geometry of the wing or wings, the tensile force indicator can be designed at less than the material yield strength of the band. The amount of force applied by the installer to the tool to achieve repositioning of the tension indicators, the wing or wings, correlates to the desired or targeted retained force for the installed band and buckle. This allows the installer to skip the subjective step of unwinding the tool tensioning screw while folding the band on top of itself and reduces the likelihood of the installation resulting in an under tensioned band. Once the indicator fully activates, the installer can simply fold the band over itself, cut it, and lock it into place by bending the buckle ears over the band. By removing the unwinding step, the retained force has been shown to be both higher on average and consistently attained, therefore reducing variability seen from installer to installer. Additionally, this targeted retained force is achieved at a lower maximum clamping force, which can be advantageous for a number of potential reasons including increased factor of safety on band/buckle damage, tool complexity/strength, etc.

In yet another embodiment, the locking ears may be configured with an alignment feature that provides the installer with a visual indication that the tension indicator completely moved to the second or installed position. For example, adding an extension or nose to at least one of the locking ears provides a sight line indicative of the tension indicator being in the desired second position.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions. It should be understood, of course, that the invention is not necessarily limited to the particular embodiments illustrated herein.

FIG. 1 is an isometric view of a prior art manual tension tool, band and buckle.

FIG. 2A is a side view of the prior art tension tool, band and buckle of FIG. 1;

FIG. 2B is an enlarged view of a portion of the tension tool, band and buckle of FIG. 1, as noted in FIG. 2A.

FIG. 3 is an isometric view of the buckle shown in FIGS. 1 and 2.

FIG. 4 is an isometric view of the prior art manual tension tool and band of FIGS. 1 and 2, with a first embodiment of a buckle according to aspects of the present disclosure.

FIG. 5 is a side view of the tension tool, band and buckle of FIG. 4.

FIG. 6 is an enlarged view of a portion of the tension tool, band and buckle of FIG. 5 as noted in FIG. 5.

FIG. 7 is a bottom, tilted view of the buckle of FIG. 6 with a tension indicator in an untensioned or first state.

FIG. 8 is a bottom, tilted view of the buckle of FIG. 7 with the tension indicator in a second or fully tensioned state.

FIG. 9A is a top view of the buckle of FIG. 6 with a tension indicator in an untensioned or first state.

FIG. 9B is a front view of the buckle of FIG. 9A.

FIG. 9C is a bottom view of the buckle of FIG. 9A.

FIG. 10A is a top view of a buckle of FIG. 6 with a tension indicator in a second or fully tensioned state.

FIG. 10B is a front view of the buckle of FIG. 10A.

FIG. 10C is a bottom view of the buckle of FIG. 10A.

FIG. 11A is a top view of the buckle of FIG. 6 with a tension indicator in an untensioned or first state and a band.

FIG. 11B is a front view of the buckle and band of FIG. 11A.

FIG. 11C is a bottom view of the buckle and band of FIG. 11A.

FIG. 12A is a top view of the buckle of FIG. 6 with a tension indicator in a second or fully tensioned state and a band.

FIG. 12B is a front view of the buckle and band of FIG. 12A.

FIG. 12C is a bottom view of the buckle and band of FIG. 12A.

FIG. 13A is an isometric top view of the buckle and band of FIG. 6 with a tension indicator in an untensioned or first state.

FIG. 13B is a bottom isometric view of the buckle and band of FIG. 13.

FIG. 14A is an isometric top view of the buckle and band of FIG. 6 with a tension indicator in a second or tensioned state.

FIG. 14B is a bottom isometric view of the buckle and band of FIG. 14A.

FIG. 15 is a side view of the buckle and a band of FIG. 14A.

FIG. 16 is an isometric view of the prior art manual tensioning tool and band of FIGS. 4 and 5, with a second embodiment of a buckle according to aspects of the present disclosure.

FIG. 17 is a side view of the tension tool, band and buckle of FIG. 16.

FIG. 18 is an enlarged view of a portion of the tension tool, band and buckle of FIG. 16.

FIG. 19 is a bottom, tilted view of the buckle of FIG. 16 with a tension indicator in an untensioned or first state.

FIG. 20A is a top view of the buckle of FIG. 16 with a tension indicator in an untensioned or first state.

FIG. 20B is a front view of the buckle of FIG. 20A.

FIG. 20C is a bottom view of the buckle of FIG. 20A.

FIG. 21A is a top view of the buckle of FIG. 16 with a tension indicator in a second or fully tensioned state.

FIG. 21B is a front view of the buckle of FIG. 21A.

FIG. 21C is a bottom view of the buckle of FIG. 21A.

FIG. 22A is a top view of the buckle of FIG. 16 with a tension indicator in an untensioned or first state and a band.

FIG. 22B is a front view of the buckle and band of FIG. 22A.

FIG. 22C is a bottom view of the buckle and band of FIG. 22A.

FIG. 23A is a top view of the buckle of FIG. 16 with a tension indicator in a second or fully tensioned state and a band.

FIG. 23B is a front view of the buckle and band of FIG. 23A.

FIG. 23C is a bottom view of the buckle and band of FIG. 23A.

FIG. 24A is an isometric top view of the buckle and band of FIG. 16 with a tension indicator in an untensioned or first state.

FIG. 24B is a bottom isometric view of the buckle and band of FIG. 24A.

FIG. 25A is an isometric top view of the buckle and band of FIG. 16 with a tension indicator is a second or tensioned stated.

FIG. 25B is a bottom isometric view of the buckle and band of FIG. 25A.

FIG. 26 is a side view of the buckle and band of FIG. 25A.

FIG. 27A is a top view of a third embodiment of a buckle according to aspects of the present disclosure.

FIG. 27B is an isometric view of the buckle of FIG. 27A.

FIG. 28A is a top view of a fourth embodiment of a buckle according to aspects of the present disclosure.

FIG. 28B is an isometric view of the buckle of FIG. 28A.

FIG. 29A is an isometric view of a fifth embodiment of a buckle according to aspects of present disclosure.

FIG. 29B is a top view of a tension indicator of the buckle of FIG. 29A.

FIG. 29C is an enlarged top view of the tension indicator of the buckle of FIG. 29A.

FIG. 29D is a front view of buckle of FIG. 29A.

FIG. 30A is a geometric diagram of the indicator of the buckle of FIG. 29A is an initial position.

FIG. 30B is a geometric diagram of the indicator of the buckle of FIG. 29A in a second position indicating the band is properly tensioned.

FIG. 31 is a graph of a data set reflecting a relationship between a force applied to the buckle and a distance between the tension indicator and a sidewall of the buckle of FIG. 29A.

### DETAILED DESCRIPTION

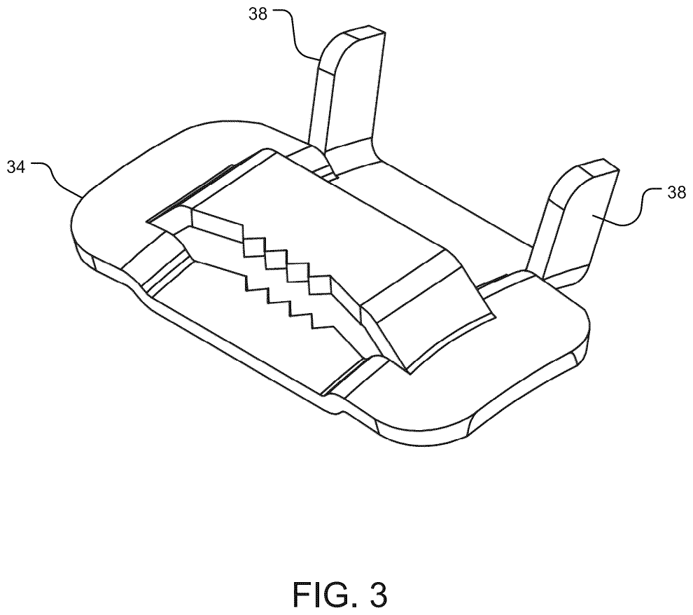

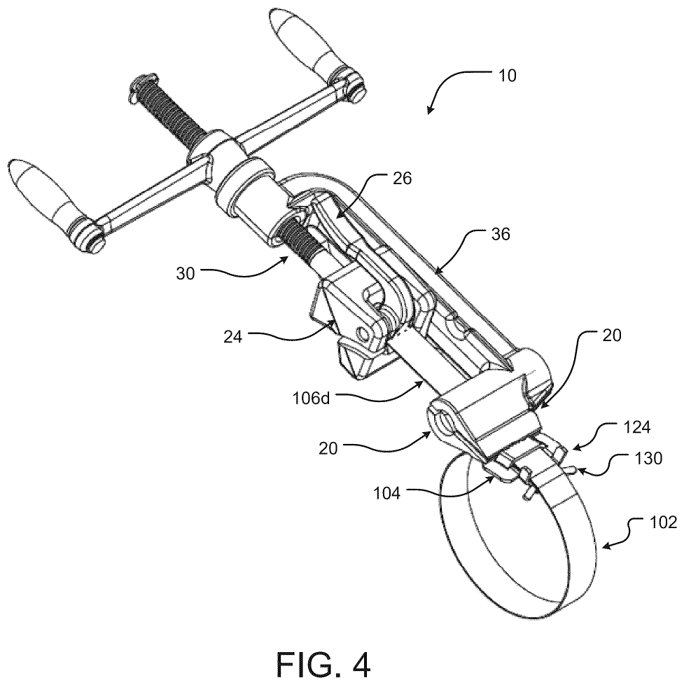

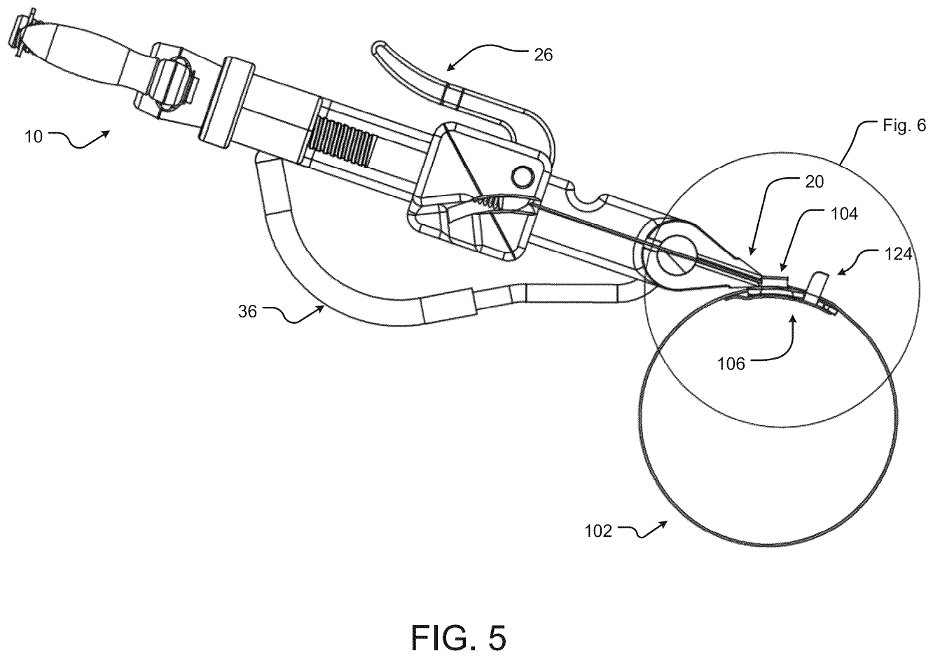

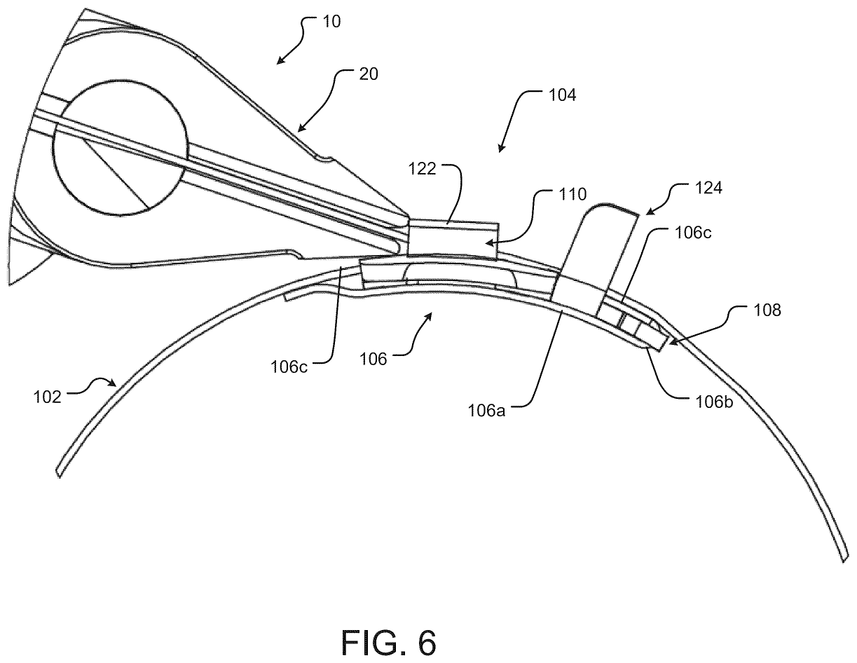

FIGS. 4-6 illustrate a tension tool 10 used to install a band 102 and a buckle 104 to a workpiece. The tension tool 10 can be handheld. A manual tool is illustrated. In other embodiments, the tool 10 could also be motorized or automatic or mounted to a fixed structure. With reference to FIGS. 5 and 6, a loop of band 106 is formed at one end of the band by the installer either prior to installation or during installation. One portion of the loop 106a is positioned under the buckle 104. A second portion 106b comprising a bend in the loop wraps around the leading end 108 of the buckle 104. A third portion of the loop 106c extends through an opening 110 in the buckle 104 and the opposite or free end of the band is wrapped around the workpiece (e.g., a pole, structure or one or more objects) and back through the buckle opening 110 once again.

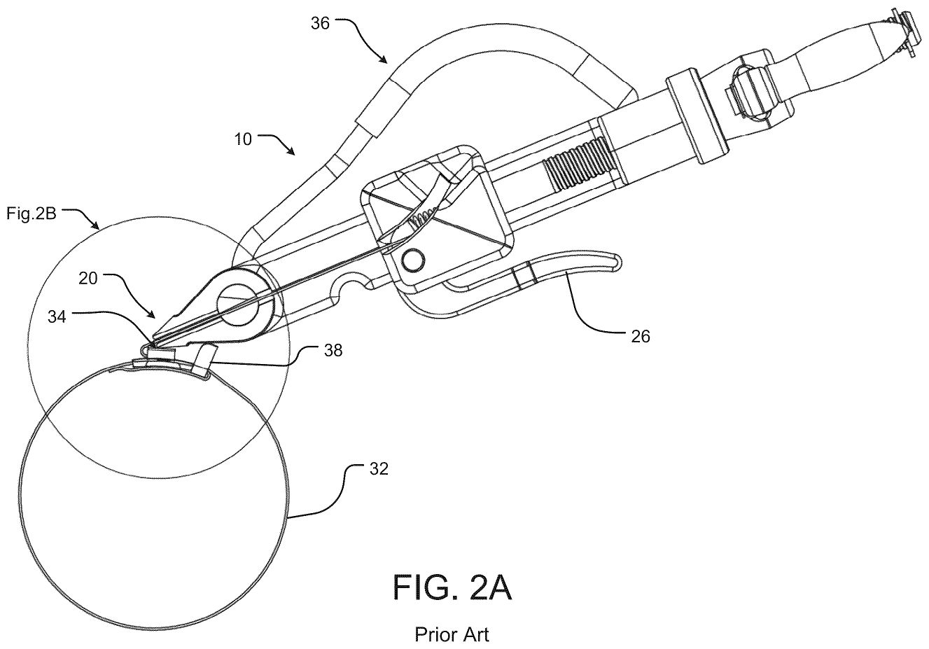

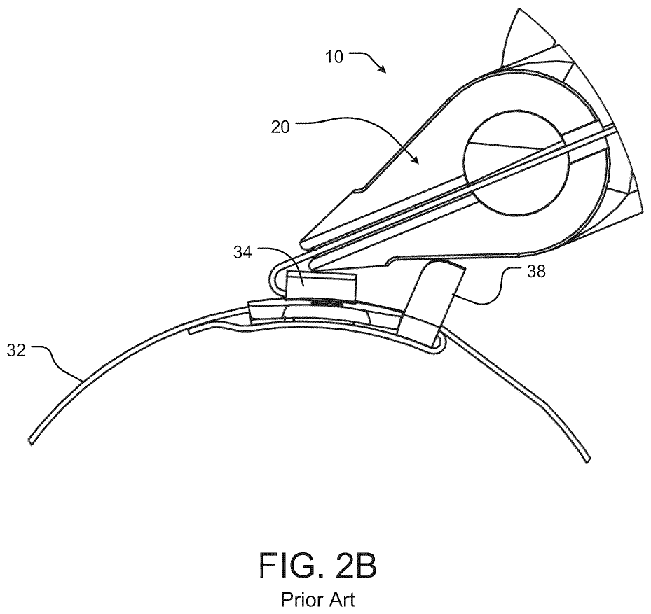

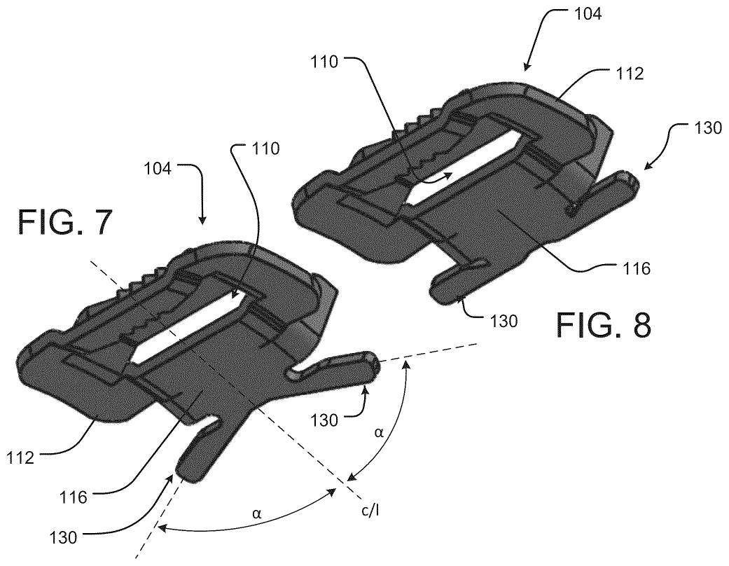

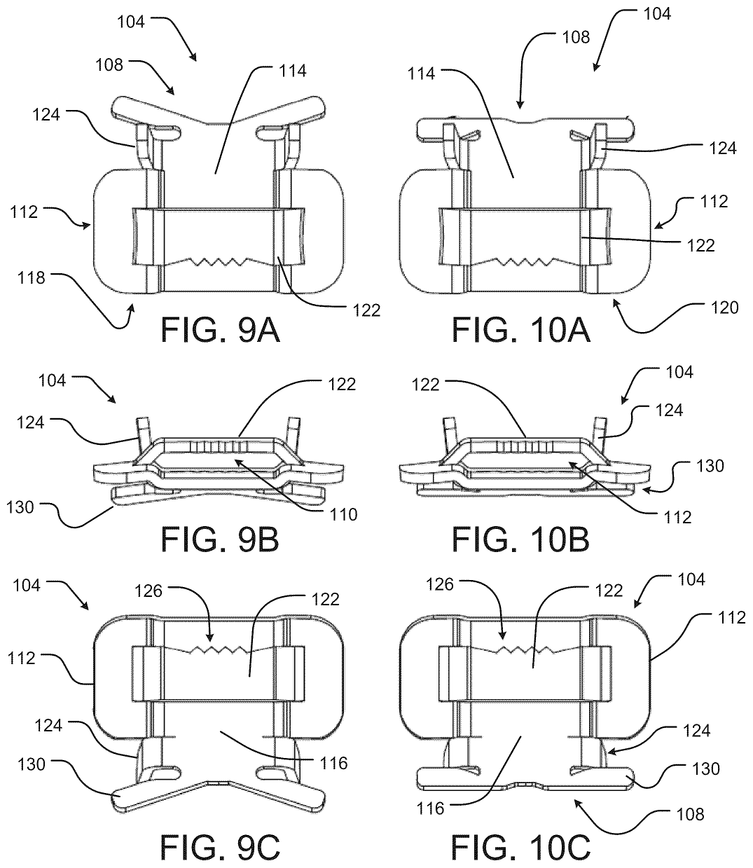

With reference to FIGS. 7-10C, the buckle has a base 112 with an upper surface 114, a lower surface 116 and a trailing end 118. The opening 110 is formed by an underside of a bridge 122 extending away from the upper surface 114 of the buckle 104 (shown in FIGS. 9B, 10B, 11B, and 12B). When tensioning is complete, the bridge 122 provides a surface over which the free end of the band 102 can be bent or rolled over and secured thereto by buckle ears 124. Teeth 126 formed on the leading end of the bridge 122 assist to secure the band relative to the buckle. Thus, when the band 102 is installed on a workpiece, the band 102 is secured to the buckle 104 at both the loop of band 106 and at the opposite end. As best seen in FIG. 4, the loop 106 of band 102 also includes a tail 106d or free end that is engaged by the tool for purposes of tensioning the band. The gripper 24 of the tension tool 10 pulls the free end 106d of the band 102 through the buckle opening, adding a tensile force to the band 102. As seen in FIG. 6, during tensioning, the nose 20 of the tool 10 presses against the buckle 104 while the bend 106b in the band loop 106 pulls on the leading end 108 of the buckle 104. To complete the installation process, the tool 10 is rotated away from the installer to bend the free end 106d of the band over the bridge 122. FIG. 2B illustrates rotation of the tool 10. Lever 36 is actuated to sever the free end or tail 106d from the band 102.

FIGS. 7 and 8 illustrate the buckle 104 with a tension indicator 130 in an untensioned or first state and a tensioned or second state, respectively. The tension indicator is formed at an acute angle α relative to a centerline c/l of the buckle. As also illustrated, the buckle 104 includes a base 112. FIGS. 9A-9C also illustrate the buckle 104 with a tension indicator 130 in an untensioned or first state and FIGS. 10A-10C illustrate the buckle 104 with the tension indicator 130 in a tensioned or second state. The buckle 104 includes the tension indicator 130 formed by two strips or tabs of metal (also referred to as wings) in the same plane as the buckle base 114 or slightly above the same plane. As illustrated, it will be appreciated that the two strips are symmetric but alternatively could be asymmetric or a varying number of wings or different geometry, material, etc. The tension indicator 130 may also include any number of wings.

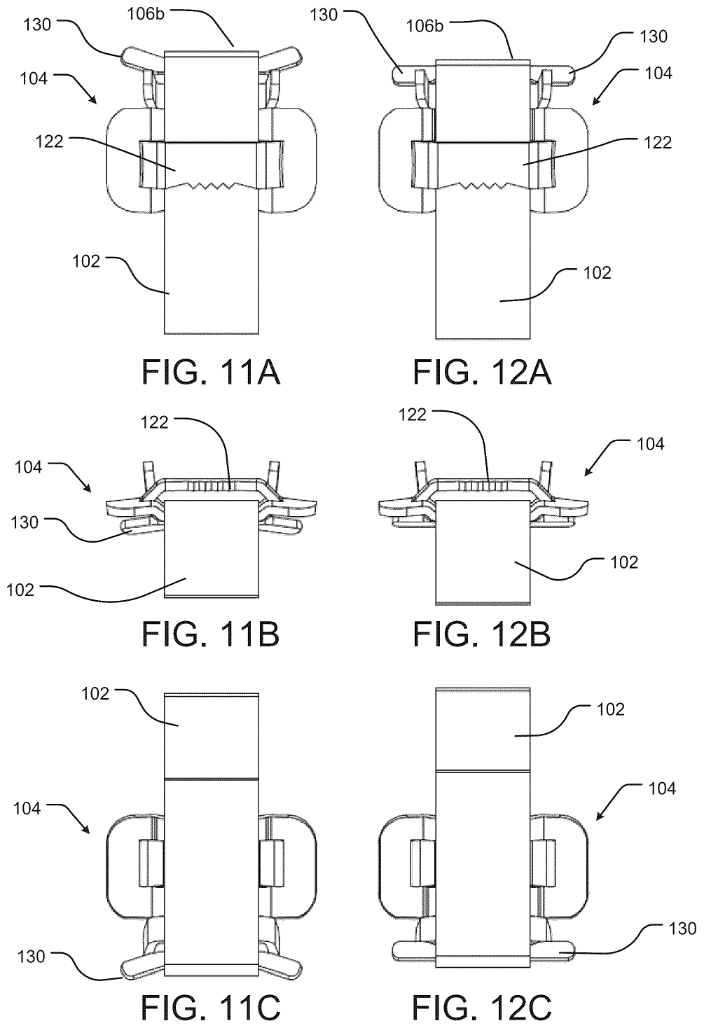

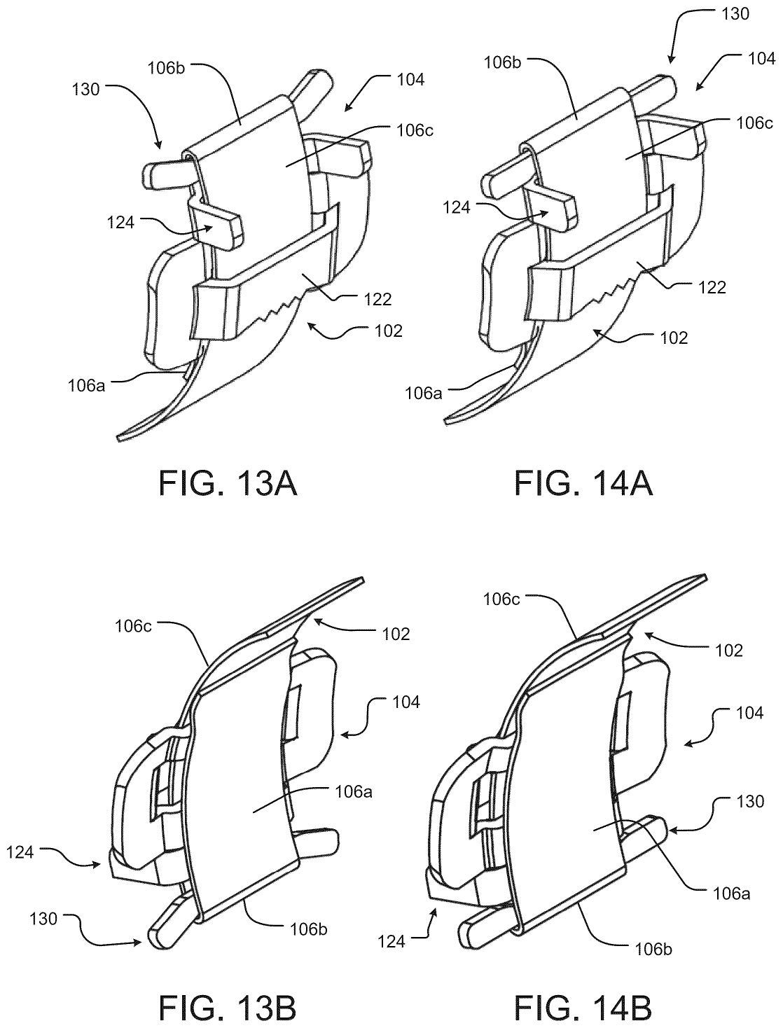

FIGS. 9A-9C, 11A-11C, and 13A-13B illustrate a first embodiment of a buckle 104 according to the present disclosure with the band 102 and the tension indicator 130 in the untensioned or first state. In contrast, FIGS. 10A-10C, 12A-12C and 14A-14B illustrate the buckle 104 with the band 102 and the tension indicator 130 in the tensioned or second state. As seen in FIGS. 11A, 11C, 12A, 12C and 13A-14B, the band loop 106b wraps over the tension indicator 130 and through the buckle 104. The bend 106b in the loop of band material 106 is wrapped around the tension indicator 130. During tensioning, the tension tool 10 pulls the free end 106d of the band 102 through the buckle 104 while the nose 20 of the tool 10 abuts or presses against the end buckle 104 at the bridge 122 or trailing end 118 or both, as seen, for example, in FIGS. 4-6. The nose 20 abutting the buckle 104 stabilizes the position of the buckle and enables the tool 10 to tension the band 102 while remaining in the same or similar position close to the workpiece. Thus, as tension is increased, the bend 106b of the loop of band 106 is pulled against the tension indicator 130 and the tension indicator 130 starts to bend or deform under the resultant compressive force of the loop of band 106 caused by the tensile force from the tension tool 10. More specifically, the tension indicator 130 moves from a first position when in an untensioned state (shown in, for example, FIGS. 9A and 11A) to a second position when the tension indicator 130 has received a desired tension (shown in, for example, FIGS. 10A and 12A). In other words, increasing the tension in the band 102, forces the tension indicator or wings 130 to transition or move to a second predetermined position visually indicating the correct tension has been met. In some embodiments, the tension indicator or wings 130 are crushed or deformed when moved between the first and second positions.

Since the desired tensile force in the band 102 can be predetermined by the material properties and geometry of the tension indicator 108, the tension indicator 108 can be designed or configured to change states at a desired tension that is less than the material yield strength of the band 102. This eliminates the initial step of over tensioning the band and the subjective step of unwinding or relaxing the tool tensioning rod while folding or rotating the band 102 on top of itself. Once the tension indicator 130 fully activates, the installer can simply fold the band 102 over itself and over the bridge 122, cut the free end 106d, and lock the band and buckle into place by repositioning one or more buckle ears 124 against the band 102. By removing the unwinding or tension relaxing step, the retained force has been shown to be both closer to the targeted retention force and more consistently achieved, therefore eliminating variability seen from installer to installer.

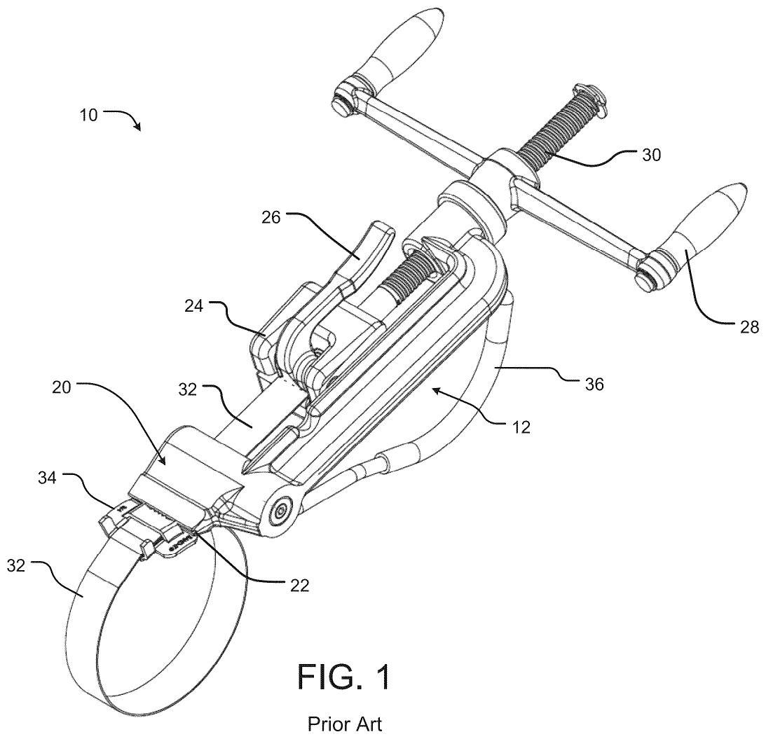

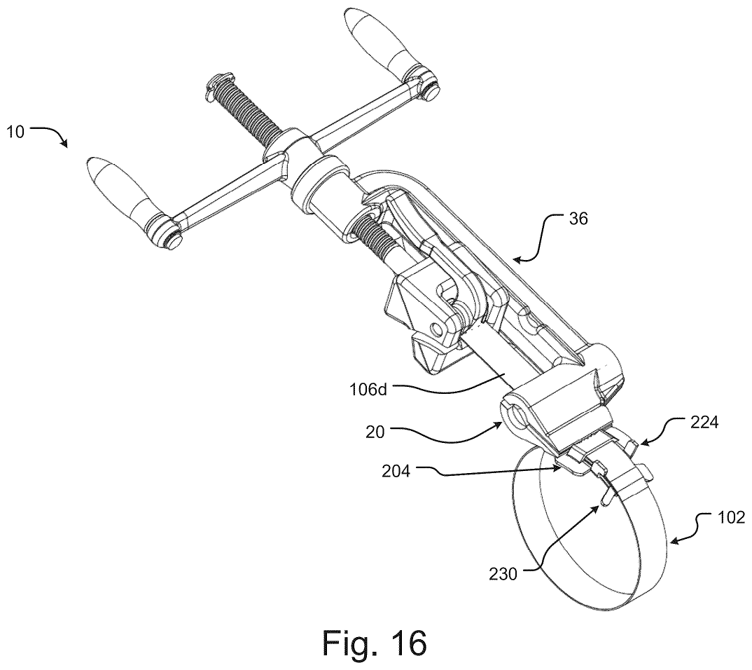

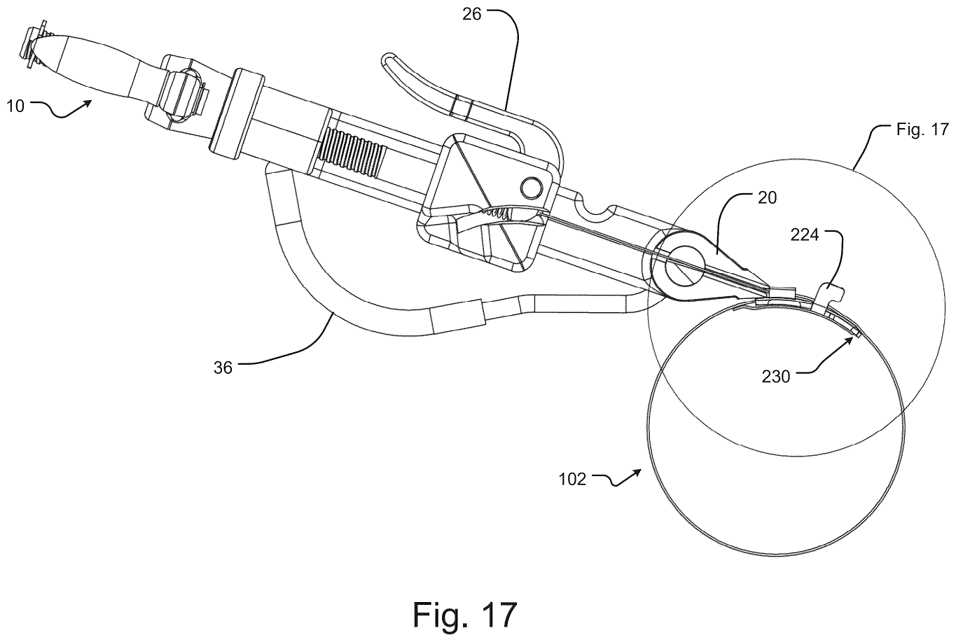

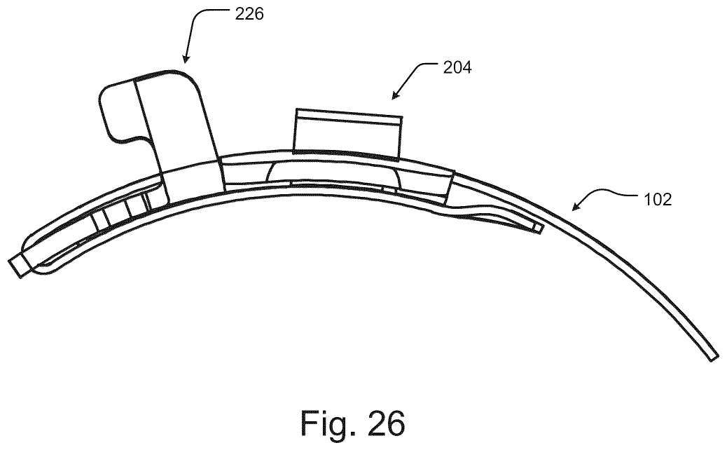

Turning to FIGS. 16-26, a second embodiment of buckle with a tension indicator according to the present disclosure is illustrated. More particularly, FIGS. 16-18 illustrate the same manual tensioning tool as illustrated in FIGS. 1-6 with a different buckle. As with the prior embodiment, a loop of band 106 is formed at one end of a band by the installer either prior to installation or during installation. One portion of the loop 106a is positioned under the buckle 204. A second portion 106b comprising a bend in the loop wraps around the leading end 208 of the buckle 204. A third portion of the loop 106c extends through an opening 210 in the buckle 204 and the opposite or free end 106d is wrapped around a workpiece (e.g., the pole or one or more objects) and back through the buckle opening 210 once again.

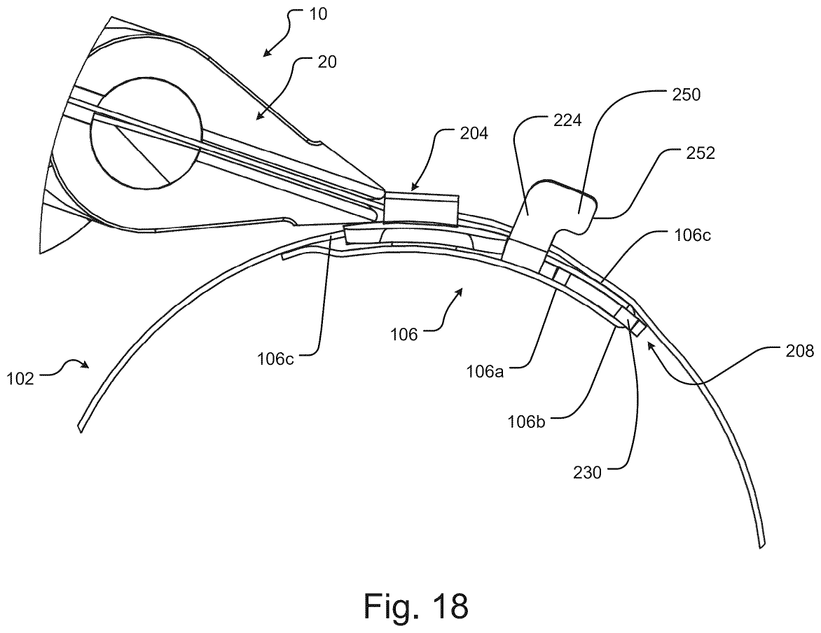

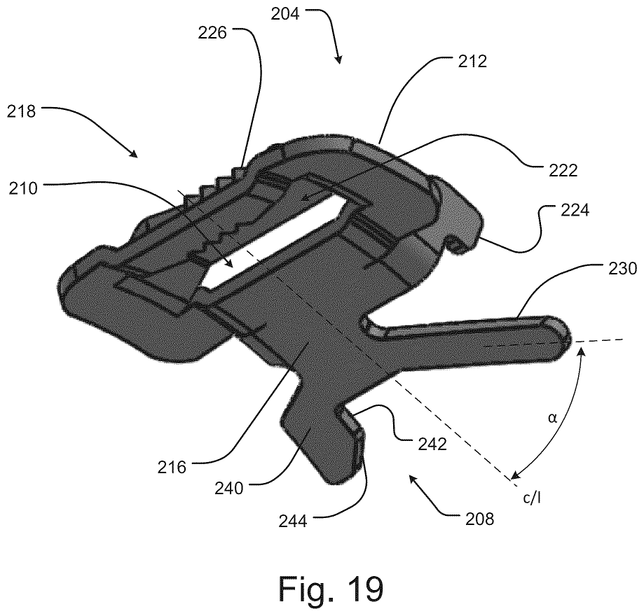

Details of the buckle 204 are best seen in FIGS. 19-26. The buckle 204 has a base 212 with an upper surface 214, a lower surface 216 and a trailing end 218. The opening 210 is formed by an underside of a bridge 222 extending away from the upper surface 214 of the buckle 204. When tensioning is complete, the bridge 222 provides a surface over which the free end of the band 102 can be bent or rolled over and secured thereto by buckle ears 224. Teeth 226 formed on the leading end of the bridge 222 assist to secure the band relative to the buckle. Thus, when the band 102 is installed on a workpiece, the band 102 is secured to the buckle 204 at both the loop of band 106 and at the opposite end. As best seen in FIG. 16, the band 102 also includes a tail 106d or free end that is engaged by the tool for purposes of tensioning the band. The gripper 24 of the tension tool 10 pulls the free end 106d of the band 102 through the buckle opening 210, adding a tensile force to the band 102. As seen in FIG. 18, during tensioning, the nose 20 of the tool 10 presses against the buckle 204 while the bend 106b in the band loop 106 pulls on the leading end 108 of the buckle 204. To complete the installation process, the tool 10 is rotated away from the installer to bend the free end 106d of the band over the bridge 222 (see, FIG. 2B that shows rotation of the tool 10 relative to a buckle). Lever 36 is actuated to sever the free end or tail 106d from the band 102.

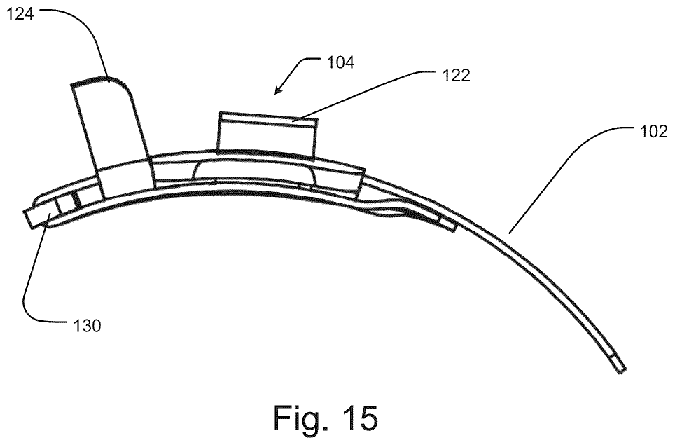

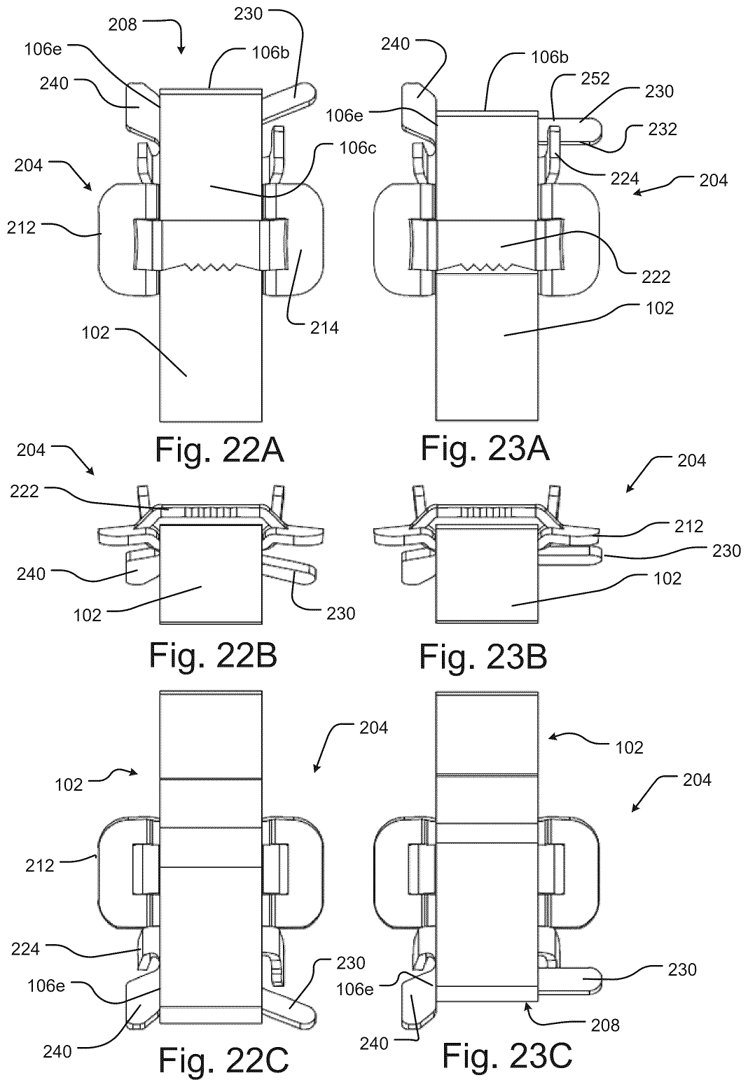

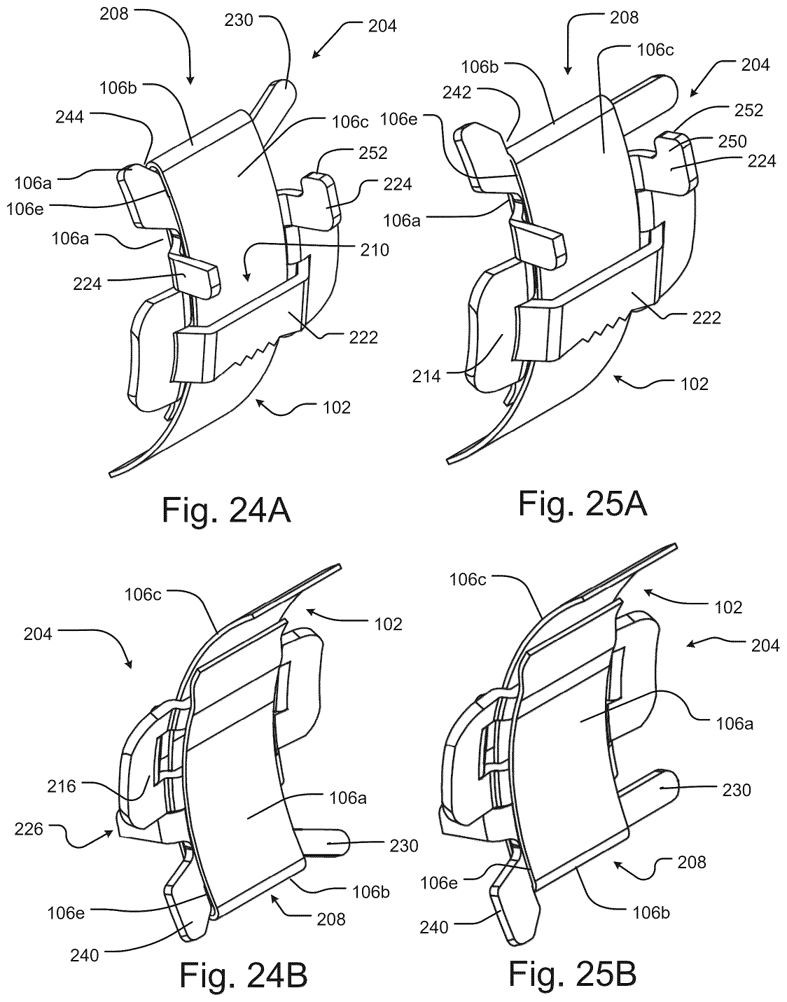

Unlike the embodiment of FIGS. 4-15, the buckle 204 of FIGS. 16-26 has a single tension indicator 230. As shown in FIG. 19, for example, the tension indicator 230 is a single tab or wing that extends from the buckle laterally outwardly proximate the leading end 218 of the buckle 204. The tension indicator is formed at an acute angle α relative to the centerline of the buckle. Opposite the tension indicator 230 and also extending from the buckle proximate the leading end 218 is a guide arm 240. The guide arm 240 includes a guide surface 242 that functions to contact a lateral edge 106e of the band 102 as seen in FIGS. 22A-23C. Comparing FIGS. 24A and 25A, as the band 102 is initially subjected to tensioning, the lateral edge 106e of the band 102 may abut the chamfer 244. Upon further tensioning, the lateral edge 106e abuts the guide surface 242 which assists in maintaining the position of the band 102 relative to the buckle 204 in order to achieve proper tensioning and proper operation of the tension indicator 230. The guide surface 242 of the guide arm 240 may also include a chamfer 244 to further assist in locating the band properly relative to the guide surface, for example, when the installer is initially beginning to tension the band 102 with a tensioning tool.

Also regarding the embodiment of FIGS. 16-26, at least one of the buckle ears 224 may be configured with a nose or extension 250 that includes a leading edge 252 (FIGS. 18, 24A and 25A), With reference to FIG. 23A, when the tension indicator 230 has moved to the second position, the lateral edge 232 of tension indicator 230 will align with the leading edge 252 of the extension 250 of the ear lock 224, which when viewed directly from above. The visual confirmation can be done before the ear lock 224 is bent or after it is bent. The edges 232 and 252 will visually align in a common plane.

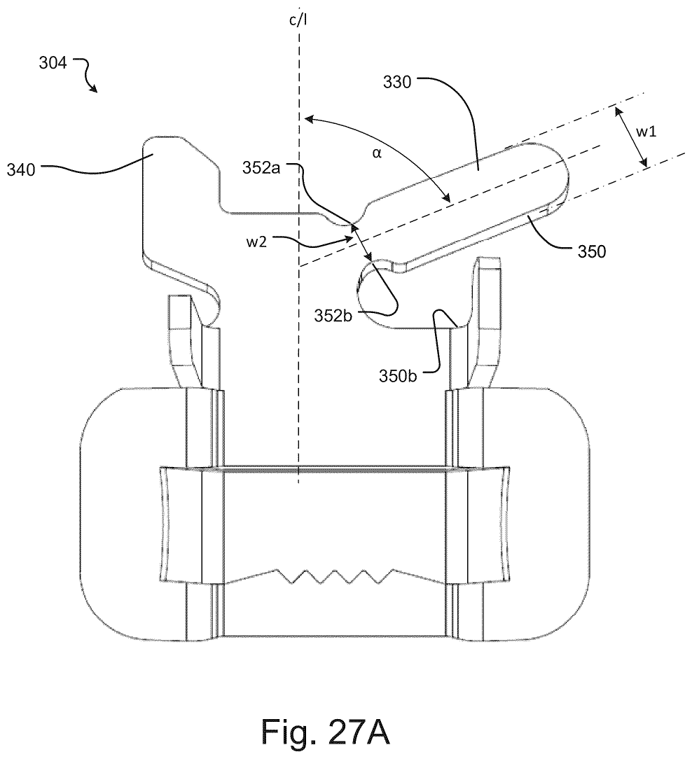

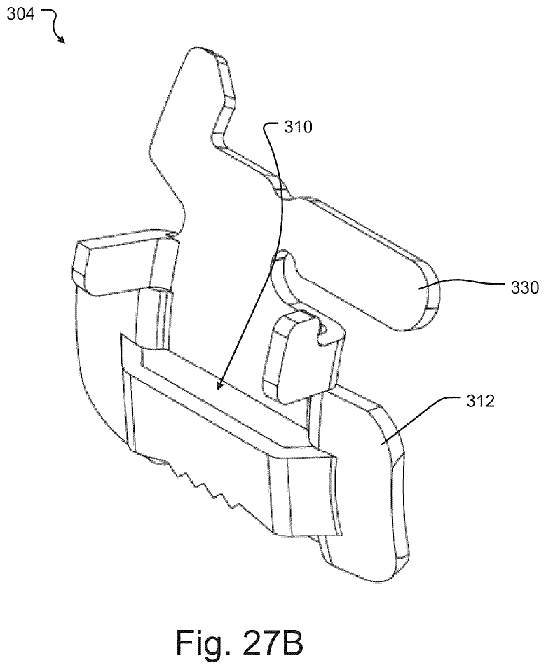

A third embodiment of a buckle 304 according to the present disclosure is illustrated in FIGS. 27A (a first untensioned state) and 27B a second tensioned state). Here, the side edge 350 of the base 312 of the tension indicator 330 includes two contours or notches 352a and 352b which function to locate the area or point where the tension indicator 330 will bend upon tensioning of the band 102. The notches reduce the lateral width of the tension indicator 330 from w₁ to w₂ and thereby define the location where the tension indicator 330 will bend. In a preferred embodiment, the cut outs are located where the indicator is expected to deform. The indicator is a moment arm that begins at the center of the top notch or cut out. The length of the moment arm may be adjusted to decrease or increase the force needed to collapse the indicator. By pre-locating or predetermining the place where the tension indicator bends or deforms upon tensioning, consistent and repeatable tension is achieved from one buckle to the next. Also, the minimum thickness from the top notch to the bottom notch is the effective width of the indicator and also plays into the force needed to collapse the indicator. In the illustrated embodiment, the notches are circular or have a fixed radius. In the illustrated embodiment, the diameter is approximately 0.140 inches, which is two times (2×) the metal thickness of the buckle.

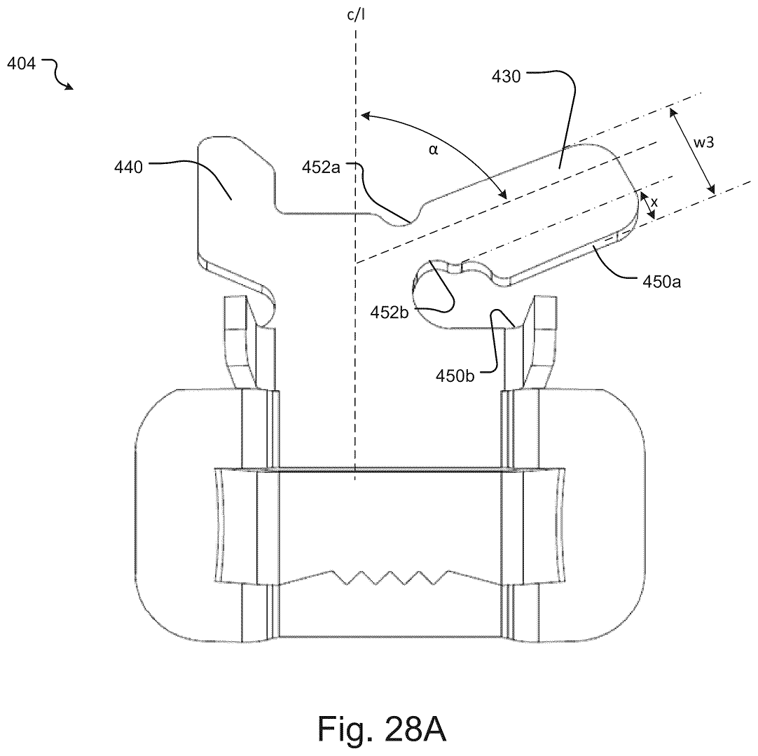

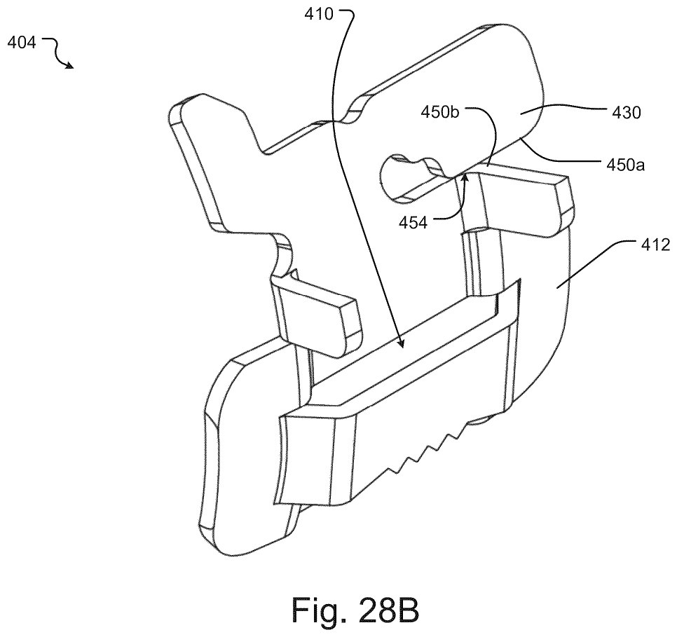

Turning to FIGS. 28A and 28B, a fourth embodiment of a buckle 404 according to the present disclosure is illustrated. FIG. 28A illustrates a first or untensioned state. FIG. 28B illustrates a second or tensioned state. Here, the width “w₃” of the tension indicator 430 is increased compared to the other embodiments, e.g., w₁ in FIG. 27A, by extending the width w₁ by a dimension “x” compared to the tension indicator 330 of FIG. 27A. In this embodiment, when the tension indicator is moved to the second position (FIG. 28B), an abutting interface 454 is formed by the two edges 450a and 450b and creates a hard stop that an operator can tactilely detect. This promotes repeatability and consistency from buckle to buckle and installer to installer. Ideally, the tension indicator 430 will move to a second state or position where the edge surface 450a will abut edge surface 450b and form an interface 454 with the two surfaces substantially parallel and abutting as shown in FIG. 28B.

In one embodiment, the buckle material is annealed 201 stainless steel, with a thickness of 0.070 plus or minus 0.0030 inches. Other metals and alloys with varying thicknesses may be used as would be understood by those of skill in the art upon review of the present disclosure.

In one example, assume a targeted retained force is about 400 lbs. Using prior art bands, buckles and manual tensioning methods, for example, as illustrated in FIGS. 1-3, the retained force of the band and buckle combination following installation may vary from 100 lbs (significantly under tensioned) to 700 lbs. With buckles made according to the embodiments of FIGS. 4-28B, the variation in retained force will be improved. For example, variation in under tensioning will be reduced and on average increased to approximately 250 lbs and upper end tensioning will remain comparable at approximately 700 lbs. As a result, the average retained force will be increased. With the embodiments of FIGS. 27 and 28, it is believed the range of variability in retained force with be further narrowed and with optimized notches or cutouts could be between 300 lbs and 400 lbs. In other words, the target retained force is achieved more consistently, which is advantageous for increasing the factor of safety on the band and/or buckle and/or reducing variability of the target retained force. The embodiments indicate that the proper tension force has been achieved, allowing the rollover process to be completed without backing off the tension force applied by the tool, eliminating a significant source of user-to-user variation.

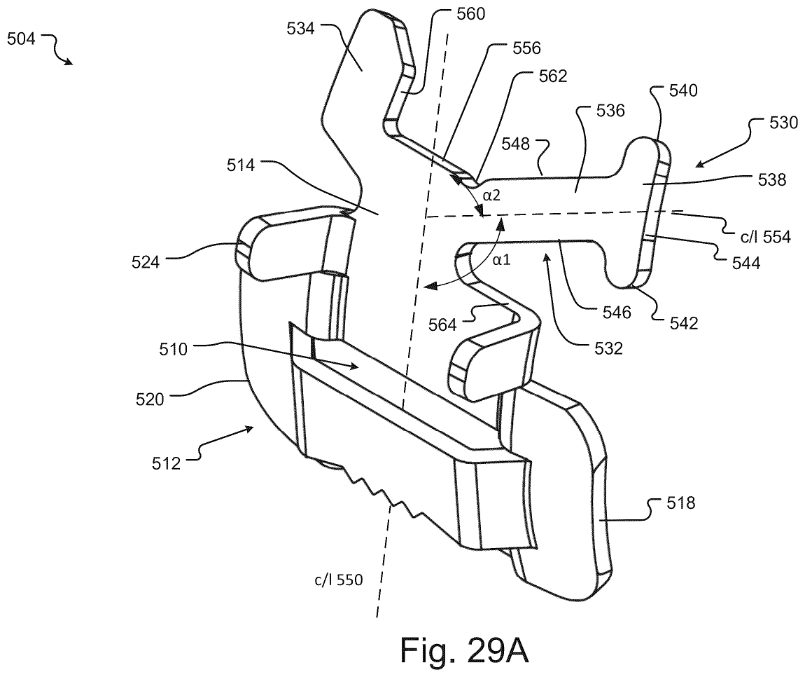

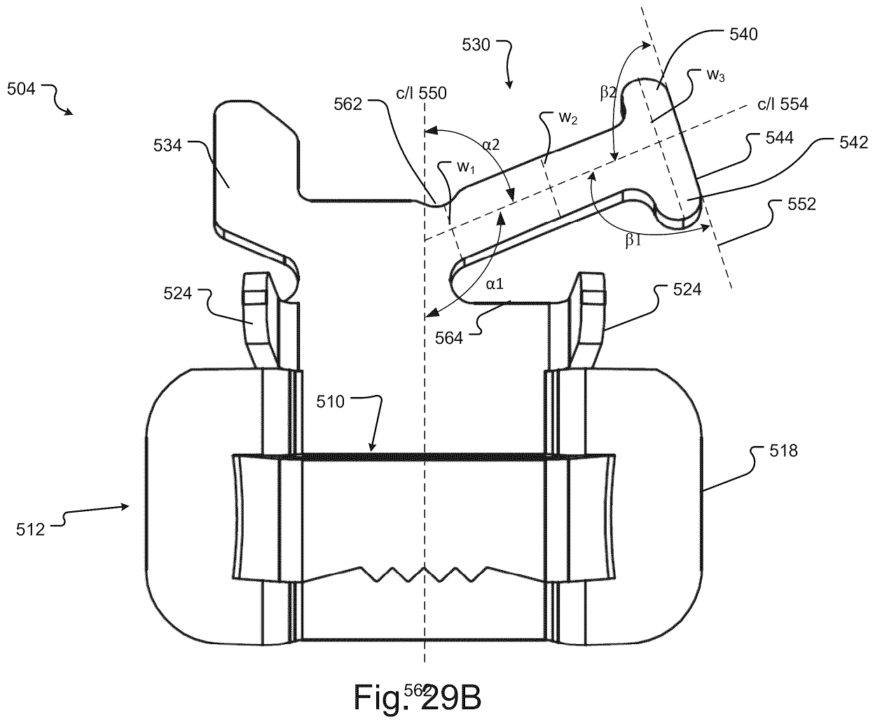

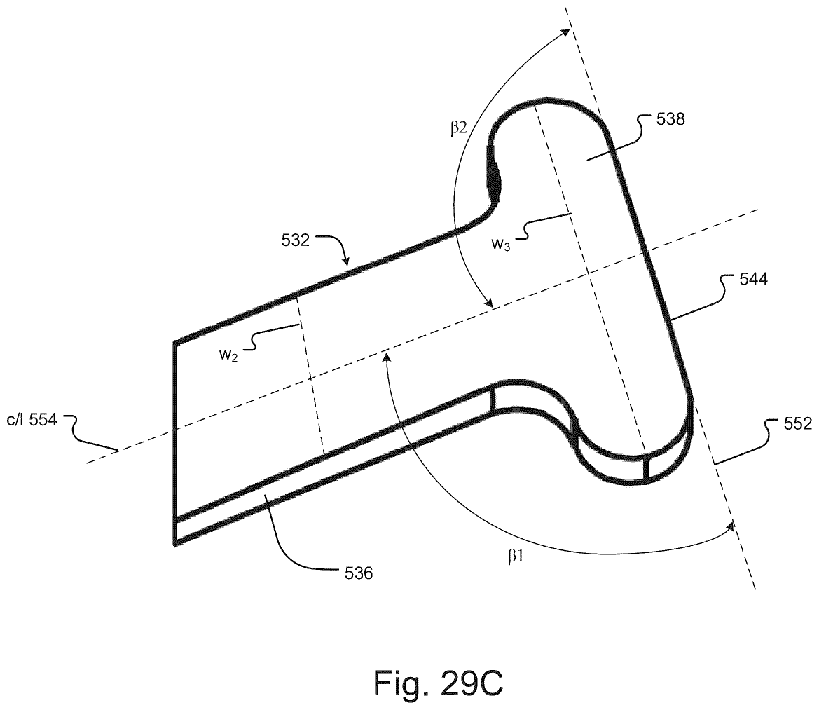

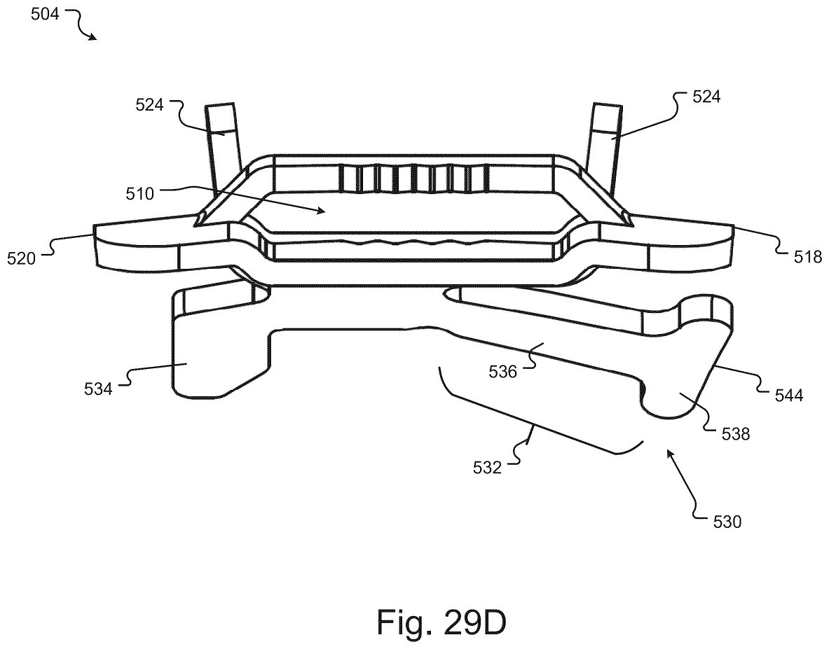

Turning to FIGS. 29A-29D, a fifth embodiment of a buckle 504 according to aspects of the present disclosure is shown. As shown in FIG. 29A, the buckle 504 includes a tension indicator 530. In embodiments, the buckle 504 has a base 512, and the base has an opening 510 constructed to receive a band. The base further has a first side edge 518 and a second side edge 520 proximately parallel to the first side edge 518. Optionally, the buckle may further have one or more ears 524 constructed to retain the band following installation. In the exemplary embodiment, the buckle 504 has two ears 524, which are spaced from each other on the buckle to be located on opposite sides of a band when the band is engaged by the buckle. After the band and buckle are secured about one or more objects, the ears are folded over the band to secure the cut end of the band relative to the buckle.

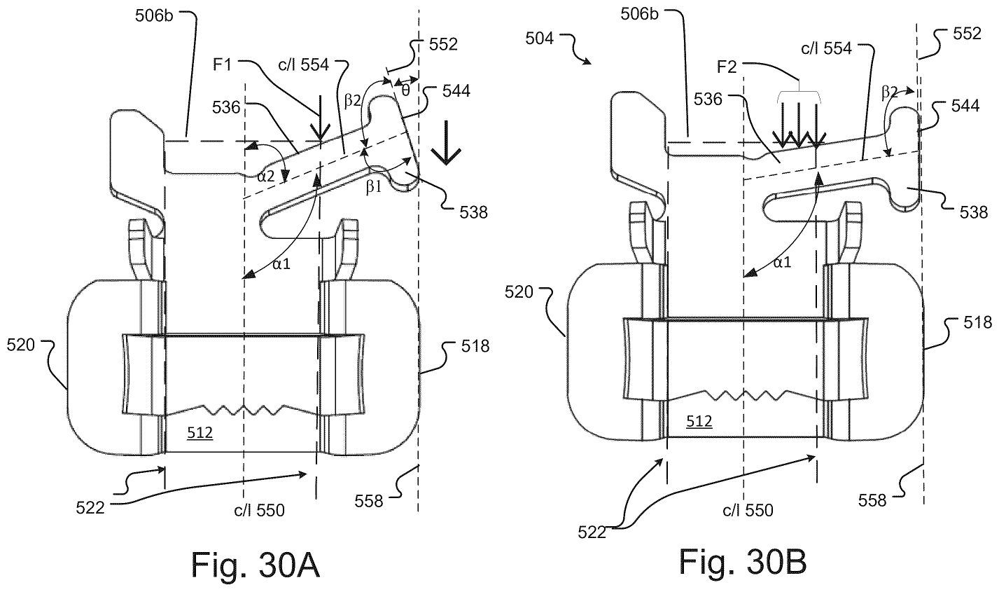

In the exemplary embodiment, the tension indicator 530 includes a tab or wing 532. The wing 532 extends laterally from the base 512 at an angle relative to a centerline 550 of the buckle. In this embodiment, the wing 532 is generally “T”-shaped, having an arm 536 and a tip 538. The arm has a sufficient length such that the tip 538 is visible to an installer when a band is associated with the buckle 504. As shown in FIGS. 30A-30B, in an initial configuration (or first state or first position), the centerline 554 of the arm 536 forms adjacent angles a1 and a2 with the centerline 550 of the buckle. Angle a1 is approximately 115 degrees, and angle a2 is approximately 65 degrees. It is appreciated that the wing angle a1 and a2 may vary in different embodiments. For example, angle a1 may vary from 105 degrees to 125 degrees and adjacent angle a2 would vary from 55 degrees to 75 degrees, respectively.

As illustrated in FIG. 29A, the tip 538 of the wing 532 has a first end 540 and a second end 542. The second end 542 of the tip 538 is opposite to the first end 540 of the tip 538 and spaced from the first end 540 at a width w₃ as seen in FIG. 29B. The tip 538 also has an outer edge or surface 544 extending between the first end 540 and the second end 542. As shown in FIG. 29C, a line 552, defined by surface 544 of the wing 532, forms two adjacent angles β1 and β2 with the centerline 554 of the arm 536. In the non-limiting example, the angle β1 is approximately 80 degrees, and the angle β2 is approximately 100 degrees. It is appreciated that the angle β1 may vary in different embodiments, ranging from 60 degrees to 85 degrees, and preferably between 70 degrees and 80 degrees, and more preferably at approximately 80 degrees. It should be appreciated that the wing 532 could also be “L”-shaped, instead of T-shaped, by eliminating one of the tip ends 540 or 542.

As shown in FIG. 29A, the arm 536 has a first edge 546 proximate to surface 564 of the base of the buckle and a second edge 548 opposite to the first edge 546 and spaced from the first edge 546 at a width w₂ of the arm 536. In this embodiment, at least one of the first edge 546 and the second edge 548 is parallel to the centerline 554 of the arm.

Reference is now made to FIGS. 30A and 30B in combination with FIGS. 29A-C. In embodiments, at a first or initial state or position (FIG. 30A) when the tension indicator 530 has not been moved or bent by tensioning of the band, the centerline 550 of the buckle 504 and the centerline 554 of the arm 536 define a wing angle a1. In a preferred embodiment, wing angle a1 is approximately 115 degrees. In addition, the edge 544 of the tip 538 of the wing 532 is oriented at a tip angle β2 relative to the centerline 554 of the arm 536 and is oriented at an oblique angle ∴ with respect to a line 558 that is colinear with the first side edge 518 of the base 512. During band tensioning, when the bent portion 506b of the band 502 engages with the tension indicator 504, the arm 536 moves towards the base 512, reducing the wing angle a1 and the angle θ. When the angle θ approaches zero degrees, surface 544 of the tip 538 will be colinear or parallel with the first side edge 518 of the base 512. The lateral edges 522 of the band 502 are shown in dashed line 558 as is the bent portion 506b. Because the tip 538 is at a position laterally spaced from the edge of the band 522, the tip 538 and surface 544 are visible to an operator, and the gradual reduction of the angle a1 causes the wing angle θ to approach zero and provides a first visual indication to an installer or operator about the tension status of the band. When the edge 544 of the wing 532 and the first side edge 518 of the base 512 are approximately colinear or parallel to each other (compare dashed lines 552 and 558), a second visual indication is provided, signaling operators that a targeted tension is achieved and to refrain from applying further tension on the band. It is appreciated that the visual indicator is not limited to the positional relationship of the edge 544 and the first side edge 518. For example, the opposite side edge 520 of the base 512 of the buckle 504 may be used as a point of reference as this edge is also parallel to edge 518 of the base.

Because the angle β1 is set at less than ninety degrees, preferably approximately eighty degrees, the installer would stop tensioning before the centerline 554 of the arm 536 or edges 544 and 546 are parallel with the buckle edge 564. As a result, by stopping tensioning when the end surface 544 is parallel or substantially parallel with the first side edge 518 of the buckle, the installer does not over tension the band and the resulting force is more consistent between installations and among different installers. Thus, it should be appreciated that different physical features or indicia that are associated with the buckle may be used to provide a visual indication relative to a feature or indicia of the wing 532. It should also be appreciated that the width w₃ of the tip 538 may be lengthened or shortened.

It should be appreciated that the angles α, β, and θ are related and may be altered as understood by those of skill in the art upon review of the present disclosure for purposes of visually providing a tension status to an installer or operator. For example, with a constant angle β2, enlarging the angle α1 would require that the travel distance of the arm 536 increases from the first or initial position to the second position where the surface 544 is colinear or parallel to the edge 518. Assuming the buckle and band remain the same, e.g., they are made of the same material, having the same dimensions and thickness, increasing angle α1 would require a larger tension to be imparted to the band to achieve alignment between surface 544 and edge 518. Accordingly, a larger targeted retained force could be achieved by increasing angle α, with all other parameters remaining the same.

Similarly, without changing angle α1, decreasing the angle β2 would require that the movement of the arm 536 must increase from the first initial position to the second position to achieve a second position where surface 544 and edge 518 are colinear or parallel. Assuming all other parameters remain the same, e.g., the buckle and band are made of the same material, having the same dimensions and thickness, a larger tension would be imparted to the band. Conversely, decreasing angle α1 or β1 while maintaining all other parameters constant, achieves alignment of surface 544 and edge 518 at a lower inputted tension. Thus, it should be appreciated that the buckle is reconfigurable to provide a visual indication for a different targeted retained tension.

It should also be appreciated that the angles α1/α2 and β1/β2 may be altered to accommodate property changes of the buckle and/or the band in order to visually indicate that a desired tension force has been applied. For example, one or both angles α1 and β2 may be altered due to the thickness of the wing 532, the thickness of the band, or both, or due to the type of metal used for the buckle and band. Generally speaking, thicker material or harder material may require greater tension to be applied, and thinner material or softer metal may require less tension to be applied.

As with the embodiment illustrated in FIG. 27A, the embodiment of FIGS. 29A-D may include an arcuate contour or notch 562, which functions to locate the area or point where the tension indicator 530 will bend upon tensioning of a band. The notch reduces the lateral width of the wing 536 from w₁ to w₂ and thereby defines the location where the wing 536 will bend. In the illustrated embodiment, the notch has a constant radius.

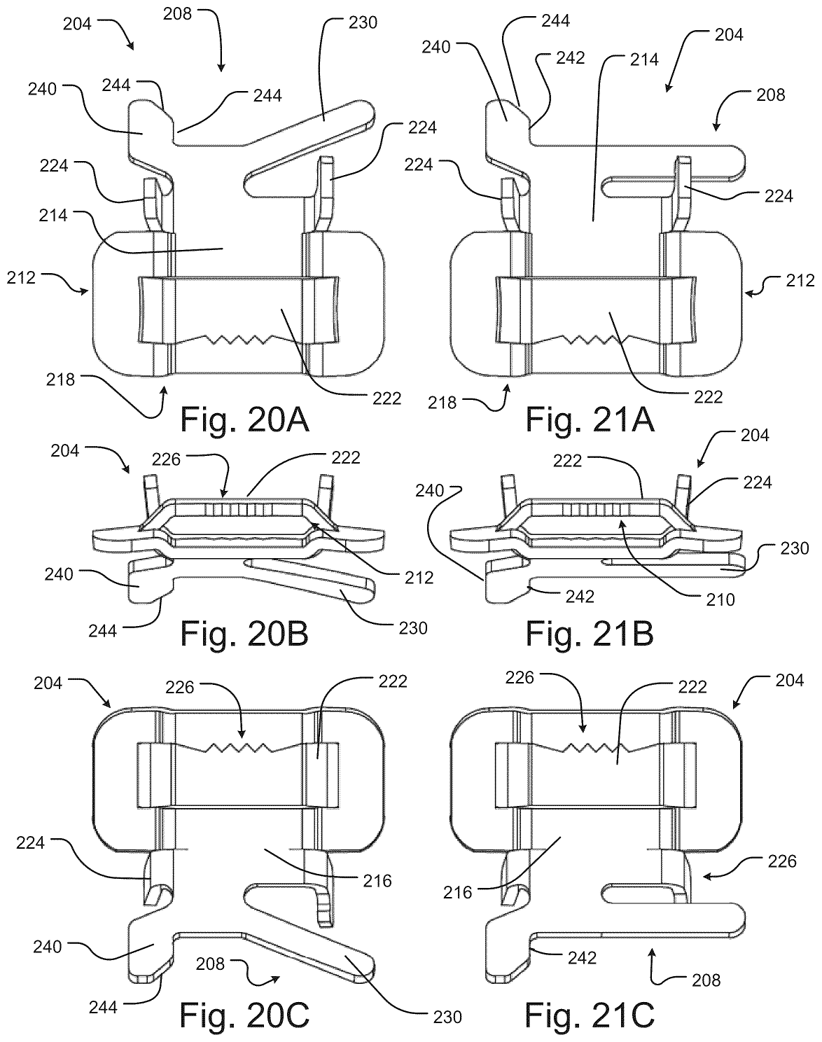

Opposite the tension indicator 530 and also extending from the buckle proximate the leading end 556 is a guide arm 534. The guide arm 534 includes a guide surface 560 that functions to contact and guide a lateral edge of the band in the same way as described herein with respect to the embodiment illustrated in FIGS. 20-25.

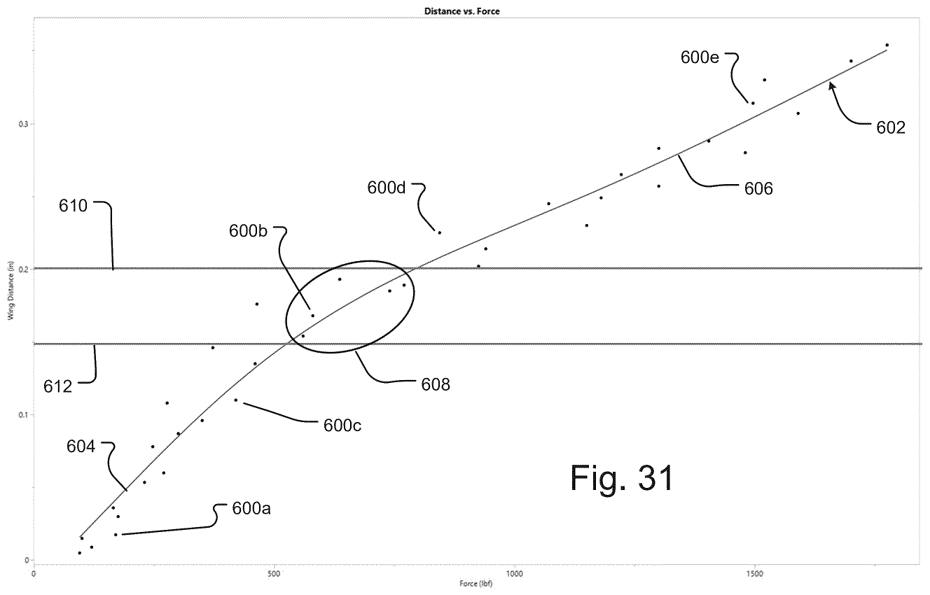

FIG. 31 provides a data set reflecting a relationship between a force applied to the band 502 and the distance the tension indicator moves relative to the buckle 504 of FIGS. 29A-29D. The collected data is illustrated by dots or points 600. The X axis is force, in lbs., and the Y axis is distance, in inches. In general terms, line 602 captures the date points 600. As seen, the line 602 has a first slope at 604 and a second slope at 606. The two slopes have a direct correlation to the orientation of the centerline 554 of the arm 536 relative to the centerline 550 of the buckle. Prior to any tension applied by a tensioning tool to a band, the indicator is in the position shown in FIG. 30A. As a tensioning force is applied to the band by the tensioning tool, the movement of the arm 536 is represented by portion 604 of line 602. Subsequently, as graphically shown by the change in slope of the line 602 at 606, the input force to the band required to move the arm 536 increases. This is because the bend 506b in the band 502 initially engages and applies a force F1 on a small portion of the arm 536 that is similar to a point load. (See, FIG. 30A.) As the arm 536 moves and angle α1 decreases, the load or force F2 applied by the bend 506b of the band on the arm 536 is distributed over a larger portion of the arm as seen in FIG. 30B. Force F2 as illustrated as multiple laterally spread arrows compared to the single arrow shown in FIG. 30A to visually represent a force distributed over a wider length of the arm 536. There is a distinct risk in an operator over tensioning the band once the band has transitioned to portion 606 of line 600 as little movement of the arm 536 is achieved with significantly increasing input force. Therefore, it is important to provide a signal or indicate to the operator or installer to stop applying an input force to the tensioning tool before the arm 536 is perpendicular or near perpendicular to the first edge 518 of the buckle. In other words, to indicate to the operator or installer that the input force on the band is within the transition zone 608, generally bounded by horizontal lines 610 and 612 which denote an acceptable range of movement of the arm 536. Line 610 represents the approximate maximum distance of travel and line 612 represents the approximate minimum distance of travel of the arm 536. This is accomplished by making angle β1 between 70 and 85 degrees, and preferably about 80 degrees. With such an orientation the surface 544 will be visually parallel with the first edge 518 before the centerline 554 is perpendicular with the first edge 518 of the buckle 504. As a result, the installer will not over tension the band and will input a consistent band tension with all bands.

By adding a tension indicator 130, 230, 330, 430, and 530 in the form of a visual indicator in the buckle 104, 204, 304, 404, and 504, respectively, that yields at a known tensile range at a predetermined orientation, the installer has a non-subjective indicator that establishes the band and buckle combination has been installed correctly with the targeted retained force to hold the desired component in place. Since there is an indication that proper tension has been achieved, the buckle 104, 204, 304, 404, and 504 enables an installation procedure which does not require the user to release tension during roll over and thus greatly reduces installation variability. The tension indicator of the various embodiments is configured to move from a first position to a second position and thereby indicate proper tension has been achieved. Optionally, a hard stop may be included as part of the buckle design to provide additional tactile feed back to the installer. Optionally, the tension indicator may be configured to deform or change its shape, i.e., be crushed, upon moving from the first to the second position.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A buckle configured to interact with a band to clamp one or more objects, the buckle comprising:
a base having a leading end and a trailing end and a first side edge and a second side edge;
at least one wing extending from the leading end of the base and having a distal end, the distal end having an edge; and
a bridge extending away from the upper surface of the base and defining an opening between an underside of the bridge and the upper surface of the base;
wherein when the band is undergoing tensioning by moving through the opening in a direction toward the trailing end of the base, the band engages the at least one wing, wherein the at least one wing is configured to move toward the trailing end of the base from a first position to a second position, and wherein a visual indication of band tension is provided by the position of the edge of the distal end of the wing relative to at least one of the first side edge and the second side edge of the base of the buckle.

2. The buckle of claim 1, wherein a visual indication to stop tensioning the band occurs when the edge of the distal end of the wing is parallel or colinear with at least one of the first side edge and second side edge of the base of the buckle.

3. The buckle of claim 1, wherein wing comprises an arm with a leading edge, a trailing edge and a tip at the distal end of the arm, the tip having a first end and a second end spaced from the first end, and wherein the arm has a first width defined by the distance between the leading of the arm and trailing edge of the arm and the tip has a second width defined as the distance from the first end of the tip to the second end of the tip, and wherein the second width is greater than the first width.

4. The buckle of claim 3, further comprising an arcuate shaped recess formed in at least one of the first side edge and second side edge of the arm.

5. The buckle of claim 3, wherein the first side edge and second side edge of the base of the buckle define a centerline of the buckle, the leading edge and the trailing edge of the arm define a centerline of the arm, the centerline of the arm forms a an acute angle with the centerline of the buckle as measured on the leading edge side of the arm, and the angle is between approximately 55 and 75 degrees.

6. The buckle of claim 5, wherein a line colinear with the edge of the distal end of the tip forms an angle with the centerline of the arm as measured on the trailing side of the arm between approximately 60 and 85 degrees.

7. A buckle configured to interact with a band to clamp one or more objects, the buckle comprising:
a base having a leading end, a trailing end, a first side edge and a second side edge spaced from the first side edge, and a centerline defined by the first side edge and the second side edge and extending through the leading end and the trailing end, the first side edge and second side edge laterally spaced from the centerline;
a tension indicator comprising a wing extending laterally away from the base in a first position, the wing having a distal end, and the distal end having an upper surface and a lower surface and a distal end surface extending between the upper surface and the lower surface, the wing configured to move between a first position and a second position;
wherein, in the first position, the distal end surface of the wing has a first portion that is oriented at an angle with respect to a line that is colinear with the first side edge of the base of the buckle, and in the second position, the first portion is parallel with the line that is colinear with the first side edge of the base of the buckle.

8. The buckle of claim 7, wherein the wing is T-shaped.

9. The buckle of claim 7, wherein the wing comprises an arm extending from the base of the buckle, the arm having leading side, a trailing side and a tip at the distal end of the arm, the tip having a first end and a second end spaced from the first end, and wherein the arm has a first width defined by the distance between the leading side of the arm and trailing side of the arm and the tip has a second width defined as the distance from the first end of the tip to the second end of the tip, and wherein the second width is greater than the first width.

10. The buckle of claim 9, wherein the leading side and the trailing side of the arm define a centerline of the arm, and wherein the tip has a distal end surface corresponding to the distal end surface of the wing, and the distal end surface of the tip is oriented at an obtuse angle relative to the centerline of the arm measured on the leading side of the wing, with the first end of the tip closer to the centerline of the base of the buckle than the second end of the tip.

11. The buckle of claim 7, wherein the tension indicator and the first side edge of the base of the buckle are positioned on the same side of the centerline of the base of the buckle and the second side edge of the base of the buckle is positioned on the opposite side of the centerline of the base of the buckle.

12. The buckle of claim 10, wherein the acute angle is between approximately 70 degrees to 85 degrees.

13. The buckle of claim 10, wherein the acute angle is approximately 80 degrees.

14. A method of tensioning a band clamp, comprising:
providing a buckle, the buckle comprising:
a base, the base having a leading end, a trailing end, a first side edge and a second side edge spaced from the first side edge, and a centerline extending through the leading end and the trailing end, the first side edge and second side edge laterally spaced from the centerline;
a tension indicator comprising an arm having a leading side, a trailing side and a distal end surface, the arm extending laterally away from the base in a direction toward the first side edge of the base, the leading side forming an acute angle with the centerline of the base;
a bridge extending away from the upper surface of the base and defining an opening between an underside of the bridge and the upper surface of the base;
providing an elongate band having a first end and a second end, an approximate 180 degree bend formed at the second end of the band, the band extending though the opening with the interior portion of the bend contacting the leading end of the base;
looping the leading end of the band around one or more objects;
inserting the leading end of the band through the opening such that a portion of the band contacts the leading side of the tension indicator;
connecting the leading end of the band to a tensioning tool;
applying an increasing tension to the band using the tensioning tool to move the tension indicator toward the trailing end of the buckle until the arm of the tension indicator moves to a predetermined position.

15. The method of claim 14, wherein the predetermined position of the arm is when the distal end surface of the arm is substantially parallel with the first side edge of the base.

16. The method of claim 14, wherein the distance between the leading side and the trailing side of the arm defines an arm width and the length of the distal end surface of the arm is greater than the arm width.

17. The method of claim 14, wherein the tension indicator has a centerline between the leading side and the trailing side, and wherein the predetermined position of the tension indicator is a location before the centerline of the tension indicator is perpendicular with a line colinear with the first side edge of the buckle.
